(19) United States
(12) Patent Application Publication
(10) Pub. No.: US 2003/0175483 A1
(43) Pub. Date: Sep. 18, 2003

(54) Adhesive tape for detecting unauthorized opening of a package

(76) Inventors: Bernhard Mussig, Seevetal (DE); Ralf Schliephacke, Itzehoe (DE); Andreas Schroder, Hamburg (DE); Dieter Wenninger, Singapore (SG)

Correspondence Address: KURT BRISCOE, NORRIS, MCLAUGHLIN & MARCUS, P.A., 220 EAST 42ND STREET, 30TH FLOOR, NEW YORK, NY, 10017, US

(21) Appl. No.: 10/333,875

(22) PCT Filed: Jul. 27, 2001
(86) PCT No.: PCT/EP01/08741

(30) Foreign Application Priority Data
Jul. 27, 2000 (DE) 100 36 708.9

(51) Int. Cl. B32B 1/00

(52) U.S. Cl. 428/192; 428/343; 428/220

(57) ABSTRACT

The invention relates to an adhesive tape which proves that a package has been opened in an unauthorised manner, comprising a composite cyclic polyolefin based support covered on one side with an adhesive material.

The invention relates to an adhesive tape having a backing based on—polyolefins which is coated on one side with adhesive composition and to its use particularly to detect unauthorized broaching of a package.

Theft, product piracy and blackmail of, for example, food companies and trading chains are leading to ever greater economic losses and damage. The use of security systems and security closures for protecting against unremarked broaching of goods and the associated possibility of manipulation of the contents is therefore of increasing importance.

Security systems for detecting unauthorized broaching are known. Security labels are of particular significance in this context. For example, U.S. Pat. No. 4,184,701 describes security labels which are composed of a plurality of ink layers and/or release layers and which as a result exhibit little adhesion of the product layers to one another. In combination with a strongly adhering adhesive composition, such layers separate from one another irreversibly, thereby indicating the broaching of the package.

Furthermore, DE 34 31 239 A1, for example, describes the use of security labels for detecting the unauthorized broaching of a package, said labels comprising a backing material of low tear propagation resistance. In combination with a strongly adhering adhesive composition, the security label is destroyed irreversibly on removal and thus indicates the attempted broaching.

The security label has a lower, first adhesive layer, which is to be detached from a backing and to be applied to the packaging, and is located on the bottom side of a first label material on whose top side there is applied—via a second adhesive layer—a second label material. The extent of the bond strength of the first adhesive layer between the packaging and the first label material is different than the extent of the bond strength of the second adhesive layer between the first label material and the second label material.

Adhesive packaging tapes for detecting the unauthorized broaching of packaging cartons and other packaging forms are likewise known. For example, EP 0 404 402 A2 and U.S. Pat. No. 4,876,123 describe multilayer carton sealing tapes which in the case of an attempted broaching ensure a transfer of lettering to the packaging surface and thus constitute a securement against broaching. However, this necessitates a bond area which is relatively large and at the same time planar.

When security labels are used for securement against broaching, it is necessary to use an appropriate release paper in order to enable security labels to be applied by machine. The use of the necessary release paper results in an unfavorably high level of complexity associated with the handling of security labels, the production of large amounts of release paper as a waste product from the application of the labels, and a very low level of flexibility in terms of adapting the security closure to the respective packaging system or to the respective system of broaching the packaging. Owing to the fixed size and structure of the label, one particular type of security label can be used only for one particular packaging.

In the case of security labels and of the known adhesive carton sealing tapes for product securement, the multilayer product structure and the use of ink layers and release layers means that complex and laborious production concepts are necessary for the production of such security systems. When these adhesive tapes are used for product securement, for the bonding of complex product closures and/or complicated consumer products, the structure of the products means the detection of unauthorized broaching is unsatisfactory.

The shrink films (sleeves) which may likewise be used for detecting unauthorized broaching exhibit disadvantages in terms of a lack—in some cases—of individualization and in terms of very high material consumption.

Plastics or films based on cyclic polyolefins are employed for various use preferably in the field of the automobile industry, optical and electrical industry.

Cycloolefin copolymers are prepared, for example, by the metallocene-catalyzed polymerization of ethylene and norbornene (bicyclo[2.2.2]hept-2-ene). Through metallocene catalysis it is possible to prepare both random (amorphous) and alternating (partly crystalline) polymers and so to set the mechanical properties. The concentration of norbornene here determines the glass transition point of the polymer.

In deviation from this it is also possible to use dicyclopentadiene, which is obtained in the C5 fraction in the course of petroleum fractionation. Owing to the presence of suitable catalysts such as, for example, aluminum alkyl, dicyclopentadiene can be polymerized by ring opening to give a thermoplastic. On the basis of its thermoplastic properties the material can be formed to a film by customary extrusion methods (for example, film blowing methods, flat film extrusion).

When film based on cyclic polyolefins is used, the nature of the longitudinal cutting process employed is important for the tensile strength and elongation at break of the product. The cut-edge quality resulting from the choice of longitudinal cutting process employed may produce either a sharp cut edge or a rough cut edge, which greatly influences the tensile strength and elongation at break of the longitudinally cut films.

It is an object of the present invention to specify an adhesive tape which on removal from the surface of the packaging is destroyed and undergoes irreversible self-division or destruction, and which renders reattachment in the original condition impossible, so that there is perceptible evidence of manipulations of quantitative or qualitative type on the packaged product. Moreover, the tape should unwind easily and exhibit a good bond between adhesive composition and backing.

This object is achieved by means of an adhesive tape as specified in the main claim. The subclaims relate to advantageous developments of the subject matter of the invention and to advantageous applications of the adhesive tape.

The invention accordingly provides an adhesive tape comprising a backing based on cyclic polyolefins, whose one side is provided with an adhesive composition.

The backing is highly brittle, so that the adhesive tape overall exhibits a low tear resistance and tear propagation resistance.

Where the films are used to produce the adhesive tapes of the invention, the overall thicknesses are in particular between 15 to 120 μm, preferably between 20 to 70 μm.

Further, in accordance with the invention, the backing of the adhesive tapes of the invention may be blended with other polymers, such as, for example, noncyclic polyolefins or polyesters. In particular, the fraction of the admixed polymers may be up to 50% by weight.

In one preferred embodiment of the adhesive tape, the adhesion of the adhesive composition to the thermoplastic film based on cyclic polyolefins is improved by means of corona treatment or flame pretreatment, since the surfaces of the polyolefin-based film in particular may be treated by these widely known techniques (such as corona pretreatment and flame pretreatment).

The techniques of surface treatment are reviewed, for example, in “Surface pretreatment of plastics for adhesive bonding”/A. Kruse; G. Krüger, A. Baalmann and O. D. Hennemann; J. Adhesion Sci. Technol., Vol 9, No 12, pp 1611-1621 (1995).

In another advantageous embodiment of the adhesive tape, a primer layer has been applied between the polyolefin film and the adhesive layer.

A primer is an adhesion base composition, usually with a multicomponent structure, whose adhesion-promoting action is based in particular on the chemical reaction of the components with one another and with the substrate surfaces.

In another advantageous embodiment of the adhesive tape, the side of the polyolefin film opposite the adhesive composition bears a coating, in particular a release coating.

Release coatings on the film surface opposite the adhesive composition are in widespread use in the adhesive tape industry. An overview of release coating systems based on silicone and their use in the field of pressure sensitive adhesives is given in “Silicone Release coating” (D. Jones, Y. A. Peters in Handbook of Pressure Sensitive Adhesive Technology, Third Edition, edited by Donatas Satas, Van Reinhold New York. pp. 652-683).

The use of rear-face release coating brings about easy and uniform unwinding of the adhesive tapes. Release coatings based on solventborne carbamate systems and silicone-based system are used in particular in this context.

Release coatings based on silicone systems are particularly suitable as release coatings of the adhesive tapes of the invention. As the release coating it is preferred to use UV-curing silicone systems on a 100% basis, although solventborne silicone systems may likewise be used as release coating for the adhesive tapes of the invention.

The application rate of the release coating to the backing material is preferably from 0.1 to 3 g/m². In a further particularly preferred embodiment, the layer application rate of the release coating is set at from 0.2 to 1.5 g/m².

Adhesives which may be used include essentially all known adhesive compositions having high bond strength to the adhesion substrate that is to be packaged.

The adhesive composition of the adhesive tape of the invention may comprise an adhesive composition based on solventborne natural rubber and acrylate adhesive compositions. Preference is given to adhesive compositions based on acrylate dispersions, particular preference to adhesive compositions based on styrene-isoprene-styrene block copolymers. These adhesive composition technologies are in widespread use in the adhesive tape industry.

The application rate of the adhesive composition to the backing material is preferably from 15 to 60 g/m². In a further preferred embodiment, the layer application rate is set at from 20 to 30 g/m².

The adhesive tapes may be produced by known methods.

An overview of customary production methods is given, for example, in “Coating Equipment”, Donatas Satas in Handbook of Pressure Sensitive Adhesive Technology, second edition, edited by Donatas Satas, Van Nostrand Reinhold New York pp. 767-808. The known processes for drying and cutting adhesive tapes may likewise be found in the Handbook of Pressure Sensitive Adhesive Technology, pages 809-874.

Furthermore, the adhesive tapes of the invention may be printed by means of customary methods.

Adhesive tapes are coated industrially in wide webs, which after coating are wound up to form what are known as stock rolls. These stock rolls are unwound again and rolled to give rolls of the appropriate length. These rolls are slit to form narrow rolls in what is referred to as the longitudinal cutting method.

The longitudinal cutting method used for the adhesive tapes of the invention is the crush cut method, which by means of a rotary cutting knife subject to an applied pressure force, and a counterpressure cylinder, separates the adhesive tape lying in between in the machine direction of the adhesive tape web.

The rotary cutting knife may be designed in such a way, by means of different geometries of the cutter and different surface roughnesses on the cutter flanks, that the cut-edge roughness of the cut adhesive tape is influenced.

The cut-edge roughness has a direct influence on the tensile strength of the cut adhesive tape, i.e., the rougher the cut edge, the lower the tensile strength of the adhesive tape.

The reduction in tensile strength through the specification of a chosen cut-edge roughness increases the tendency to produce an adhesive tape which, once applied, can no longer be removed from the bonded substrate without destruction.

Through the use of specifically suitable cutting variants, therefore, it is possible to increase considerably the security effect of adhesive tapes for detecting the unauthorized broaching of a package and to broaden the use of such products.

Preferably, therefore, the edges of the polyolefin film have a serrated cut.

Finally, the concept of the invention also embraces the use of an adhesive tape of the invention on packaging for detecting the unauthorized broaching thereof by virtue of the fact that on removal from the surface of a package the adhesive tape is irreversibly destroyed and clearly indicates an attempted broaching by tearing or splitting in the thickness direction owing to the low tear propagation resistance.

Indeed, the adhesive tape of the invention is suitable for use as a security closure for clear indication of an unauthorized attempted broaching, or of a broaching, for a large number of valuable and/or sensitive goods. An important field of application here is the securement of a wide variety of consumer goods against theft, falsification of the contents, and protection against pirate copies. The unremarked broaching, theft and falsification of sensitive goods is prevented by the use of the adhesive tapes of the invention.

Relevant packaging forms include folded boxes, bottles and tubes with screw and pressure closures, shampoo bottles, folded boxes and plastic containers. Suitable surfaces for the packaging material include those of paper, cardboard, glass, polypropylene, polystyrene, polyvinyl chloride and steel, for interaction with the adhesive tapes of the invention.

Applications in the office sector, in the packaging of medical and pharmaceutical products, the securement of cosmetics and bodycare articles and of foodstuffs and luxury consumables by means of a security closure are possible. Also possible is application for securing electronic and electrical appliances.

By using an adhesive tape of the invention as a security closure to protect against unauthorized broaching, it becomes unnecessary to use a release paper as is required when using security labels. This represents a considerable cost saving and reduces the complexity and greatly reduces the resulting amount of waste. Furthermore, through the use of an adhesive tape for packaging and/or securing products, the flexibility of the types of packaging and types of closure that may be used is increased. As a result of easy unwinding during manual and mechanical application to packaging, the size of the security closure may be varied without problems and adapted to the packaging.

If an attempt is made to remove an adhesive strip of the adhesive tape of the invention from the packaging, then, owing to the bond strength of the security closure being greater than the strength of the backing, the backing will undergo irreversible destruction as a result of the low tear resistance and tear propagation resistance and the attempted broaching will be clearly and distinctly indicated. This effect may be enhanced by the use of specific cutting modifications.

The intention of the text below is to illustrate the invention with reference to an example, without wishing to restrict the invention unnecessarily.

### EXAMPLE

a: Film a

Film a: Film for the adhesive tapes of the invention

A biaxially oriented, coextruded film based on polypropylene was used, from Nippon Zeon Co. LTD.

| Film thickness: | 100 μm |
|---|---|
| Identification: | 1420R |
| Company/manufacturer: | Nippon Zeon Co. LTD |
| Elongation at break | 100% |

Film 1420 is a film based on cyclic polyolefins characterized in that it has low tear resistance and tear propagation resistance.

Film b: Film for reference sample

A biaxially oriented film based on polypropylene was used, from Radici.

| Film thickness: | 25 μm |
|---|---|
| Identification: | Radil T |
| Company/manufacturer: | Radici |
| Elongation at break, MD: | 125% |
| Elongation at break, CD: | 50% |

For both films a and b, the opposite surface of the film, that not coated with adhesive composition, was provided with a rear-side coating with the aid of the customary technologies, prior to coating.

The surface of the film that was coated with adhesive composition was corona treated prior to coating. The surface energy was>42 mN/m.

An adhesive composition based on an aqueous acrylate dispersion was used to produce the adhesive tapes of the invention and the reference sample.

c: Application of the Adhesive Composition

The coating of films a and b with the adhesive composition was carried out using a wire-wound coating bar. The coating bar and the coating rate were adjusted so that after drying the coated film a mass application of approximately 25 g/m² is measured. Coating was carried out on a pilot-scale coating unit with a working width of 500 mm at a coating rate of 10 m/min. Downstream of the coating station with wire-wound coating bar applicator unit there was a drying tunnel which was operated with hot air (approximately 100° C.). The coated film was converted in a width of 19 mm as described in d. The security effect was determined following storage at 23° C. for two days.

d: Cutting of the Adhesive-Coated Film Web

The longitudinal cutting of the film web coated with adhesive composition (films a and b) was done using rotary crush cutting knives which in terms of their cutting geometry are configured as zig-zag knives.

| | |
|---|---|
| Zig-zag knife | 0.2 mm |
| Number of teeth: | 604 |
| Cutting phase angle: | 900 |
| Tooth width: | 0.2 mm |
| Cut-face width: | <0.05 mm |

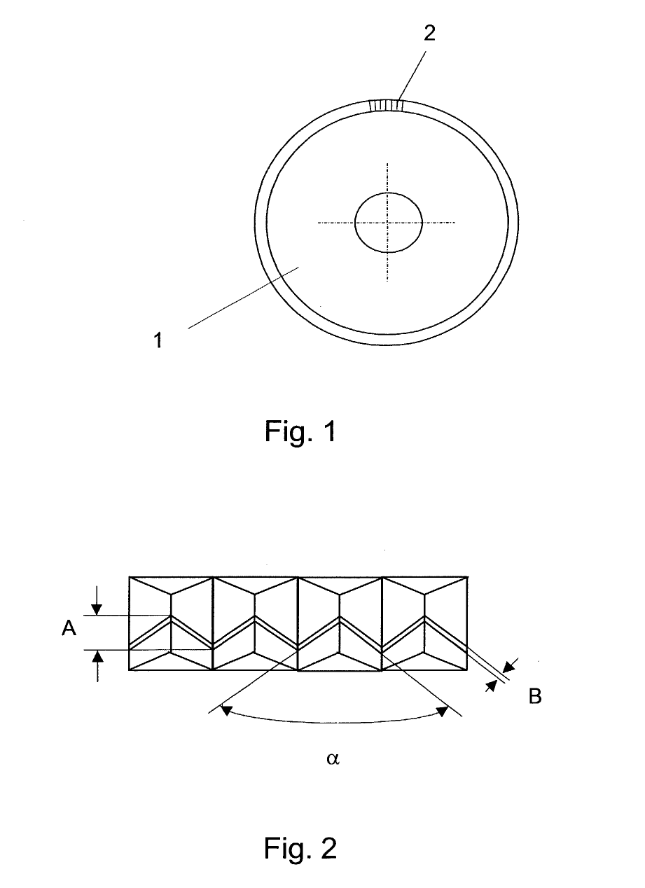

FIGS. 1 and 2 show the crush cutting knife 1 which was used. The knife 1 has 604 teeth 2. The cutting phase angle αis α=90°. The tooth width A is A=0.2 mm, the cut-face width B is less than 0.05 mm.

e: Adhesion Substrates for Testing the Security Effect

| | | |
|---|---|---|
| e1: | Polyethylene: | polyethylene sheets from Thyssen, Hamburg |
| | | Identification A27120; 50 × 200 mm; thickness |
| | | 3 mm |
| e2: | Polystyrene: | polystyrene sheets from Thyssen, Hamburg |
| | | Identification A27123; 50 × 200 mm; thickness |
| | | 3 mm |
| e3: | Polyvinyl | polyvinyl chloride sheets from Thyssen, Hamburg |
| | chloride: | Identification A27126; Komadur UPVC; |
| | | 50 × 200 mm; thickness 3 mm |
| e4: | Glass: | glass sheets from Glaserei Dietrich, Hamburg; |
| | | 50 × 200 mm, thickness 4, |
| e5: | Steel: | steel plates from Thyssen Stahl, to DIN EN |
| | | 10088-2, steel type 1.4301; |
| | | roughness Ra = ± 0.05 μm |
| e6: | Paper: | standard typewriter paper |

f: Results

To determine the security effect, the adhesive tapes produced in c were examined and compared with a reference sample. To characterize the security effect on different adhesion substrates, adhesive strips (5×1 cm) of the adhesive tapes and of the reference sample were bonded to the surfaces specified in e and were pressed on- using a steel roller weighing 2 kg (which was rolled over the bonds twice). Following a waiting time of 24 hours at 23° C., an attempt was made by hand to see to what extent the adhesive strips could be peeled or removed without destruction. In the course of these attempts, use was also made of technical auxiliary means, such as scissors or knives, for example.

Reference Sample:

Adhesive composition based on an aqueous acrylate dispersion. Backing based on a biaxially oriented polyolefin film (film b) The reference samples were produced analogously as described in c.

Adhesive strips resulting from adhesive tapes of the invention (film a):

| | Nondestructive removal possible from the adhesion |
|---|---|
| Adhesion substrate | substrates described in e |
| Polyethylene | No |
| Polystyrene | No |
| Glass | No |
| Steel | No |

Adhesive strips resulting from reference adhesive tape (film b):

| | Nondestructive removal possible from the adhesion |
|---|---|
| Adhesion substrate | substrates described in e |
| Polyethylene | Yes |
| Polystyrene | Yes |
| Glass | Yes |
| Steel | Yes |

1. An adhesive tape comprising a composite backing based on cyclic polyolefins whose one side is provided with an adhesive composition.

2. The use as claimed in claim 1, characterized in that the thicknesses of the backing are between 15 to 120 μm, preferably between 20 to 70 μm.

3. The adhesive tape as claimed in claims 1 and 2, characterized in that the edges of the polyolefin film have a serrated cut.

4. The adhesive tape as claimed in claims 1 to 3, characterized in that the backing is blended with other polymers, preferably in a fraction of up to 50% by weight.

5. The adhesive tape as claimed in at least one of the preceding claims, characterized in that the polyolefin film has been corona treated or flame treated in order to improve the adhesion of the adhesive composition to the polyolefin film.

6. The adhesive tape as claimed in at least one of the preceding claims, characterized in that a primer layer has been applied between the polyolefin film and the adhesive layer.

7. The adhesive tape as claimed in at least one of the preceding claims, characterized in that the side of the polyolefin film opposite the adhesive composition bears a coating, especially a release coating.

8. The adhesive tape as claimed in at least one of the preceding claims, characterized in that the application rate of the release coating is from 0.1 to 3 g/m², preferably from 0.2 to 1.5 g/m².

9. The adhesive tape as claimed in at least one of the preceding claims, characterized in that the adhesive composition is a solventborne adhesive composition based on styrene-isoprene-styrene copolymers.

10. The adhesive tape as claimed in at least one of the preceding claims, characterized in that the application rate of the adhesive composition is from 15 to 60 g/m², preferably from 20 to 30 g/m².

11. The use of an adhesive tape as claimed in at least one of the preceding claims for detecting unauthorized broaching of a package, by virtue of the fact that on removal from the surface of a package the adhesive tape is irreversibly destroyed and clearly indicates an attempted broaching by tearing to pieces.
